(19) United States
(12) Patent Application Publication
(10) Pub. No.: US 2017/0266835 A1
(43) Pub. Date: Sep. 21, 2017

(54) SLIDABLE WORKBENCH

(71) Applicant: Bor-Yann CHUANG, TAICHUNG CITY (TW)

(72) Inventor: Bor-Yann CHUANG, TAICHUNG CITY (TW)

(21) Appl. No.: 15/075,455

(22) Filed: Mar. 21, 2016

(51) Int. Cl. B27G 5/02; B23D 47/04; B23D 47/02

(52) U.S. Cl. CPC B27G 5/023; B23D 47/025; B23D 47/045

(57) ABSTRACT

A slidable workbench includes a shifting mechanism and a push member. The shifting mechanism includes a fixed board, two slide rails, and a sliding platform. Immovable sections of the slide rails are disposed on the top surface of the fixed board and spaced at an interval. Movable sections of the slide rails are disposed at the bottom surface of the sliding platform, enabling the sliding platform to slide on the fixed board through the slide rails. Thereby, a workpiece is pushed by the push member and the sliding platform is slidable relative to the fixed board for the user to operate a table saw in a quick, labor-saving and easy manner. The slidable workbench can be used for all kinds of saw machines to enhance the convenience and safety of the saw machines greatly and improve the quality of cutting.

### BACKGROUND OF THE INVENTION

1. Field of the Invention

The present invention relates to a slidable workbench, and more particularly to a slidable workbench for moving a workpiece conveniently.

2. Description of the Prior Art

A conventional saw machine comprises a base. The base has an accommodation space. The top of the base is provided with a worktable. The worktable has an elongate hole in communication with the accommodation space. The saw machine further comprises a motor and a seat which are disposed in the accommodation space. The seat is provided with a drive shaft. An output shaft of the motor is connected with one end of the drive shaft through a belt. Another end of the drive shaft is provided with a cutter. The cutter is exposed out of the elongate hole. When in use, the motor is actuated to drive the cutter. A workpiece is placed on the worktable. The workpiece is pushed to move toward the cutter for cutting. Although the aforesaid saw machine is able to saw and cut the workpiece, the workpiece may tilt easily because the workpiece is pushed manually. As a result, the quality of cutting is not good, and the operator may be hurt by the cutter. Accordingly, the inventor of the present invention has devoted himself based on his many years of practical experiences to solve these problems.

### SUMMARY OF THE INVENTION

The primary object of the present invention is to provide a slidable workbench for the user to operate a table saw in a quick, labor-saving and easy manner. The slidable workbench can be used for all kinds of saw machines to enhance the convenience and safety of the saw machines greatly and improve the quality of cutting.

In order to achieve the aforesaid object, the slidable workbench of the present invention comprises a shifting mechanism and a push member. The shifting mechanism comprises a fixed board, two slide rails, and a sliding platform. The slide rails each comprise an immovable section and a movable section. The immovable sections of the slide rails are disposed on the top surface of the fixed board and spaced at an interval. The movable sections of the slide rails are disposed at the bottom surface of the sliding platform, enabling the sliding platform to slide on the fixed board through the slide rails. The push member is fixedly connected to the sliding platform. Thereby, a workpiece is pushed by the push member and the sliding platform is slidable relative to the fixed board for the user to operate the table saw in a quick, labor-saving and easy manner. The slidable workbench can be used for all kinds of saw machines to enhance the convenience and safety of the saw machines greatly and improve the quality of cutting.

### BRIEF DESCRIPTION OF THE DRAWINGS

FIG. 1 is a perspective view of the present invention;

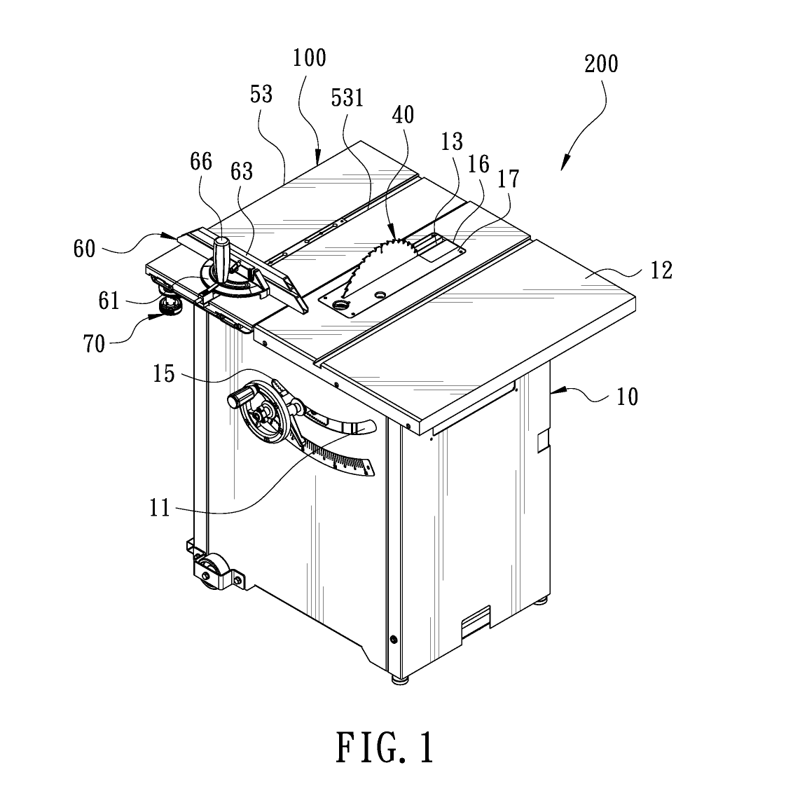

FIG. 2 is a first partial exploded view of the preferred embodiment of the present invention;

FIG. 3 is a second partial exploded view of the preferred embodiment of the present invention;

FIG. 4 is a third partial exploded view of the preferred embodiment of the present invention;

FIG. 5 is a schematic view of the present invention when in use, showing that the sliding platform is at the first position;

FIG. 6 is a schematic view of the present invention when in use, showing that the sliding platform is at the second position;

FIG. 7 is a schematic view of the present invention when in use, showing that the push member is turned an angle; and

FIG. 8 is a schematic view, showing that the present invention is braked.

### DETAILED DESCRIPTION OF THE PREFERRED EMBODIMENTS

Embodiments of the present invention will now be described, by way of example only, with reference to the accompanying drawings.

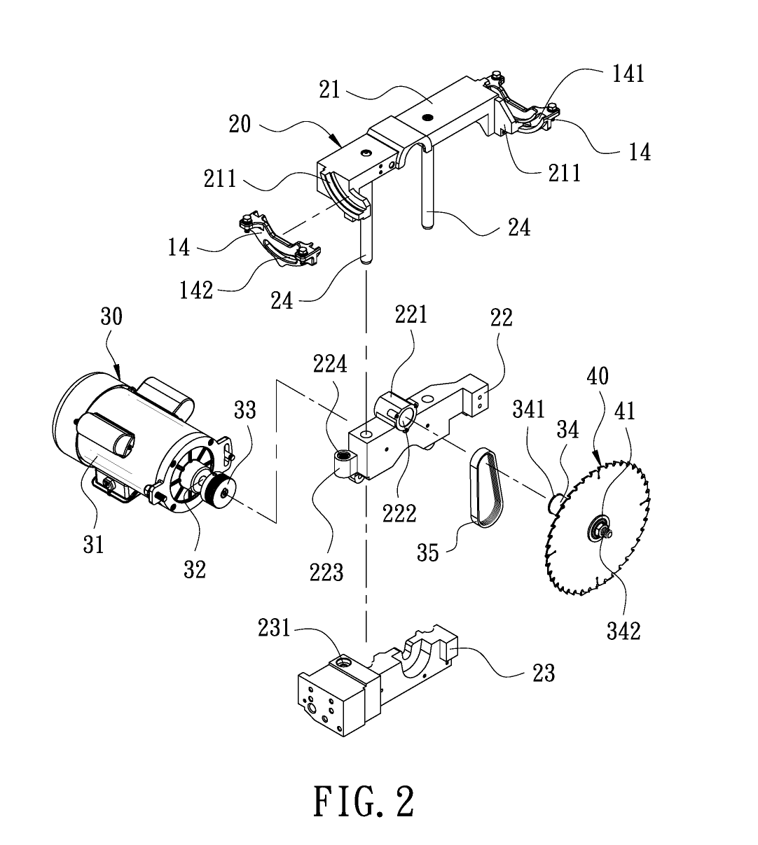

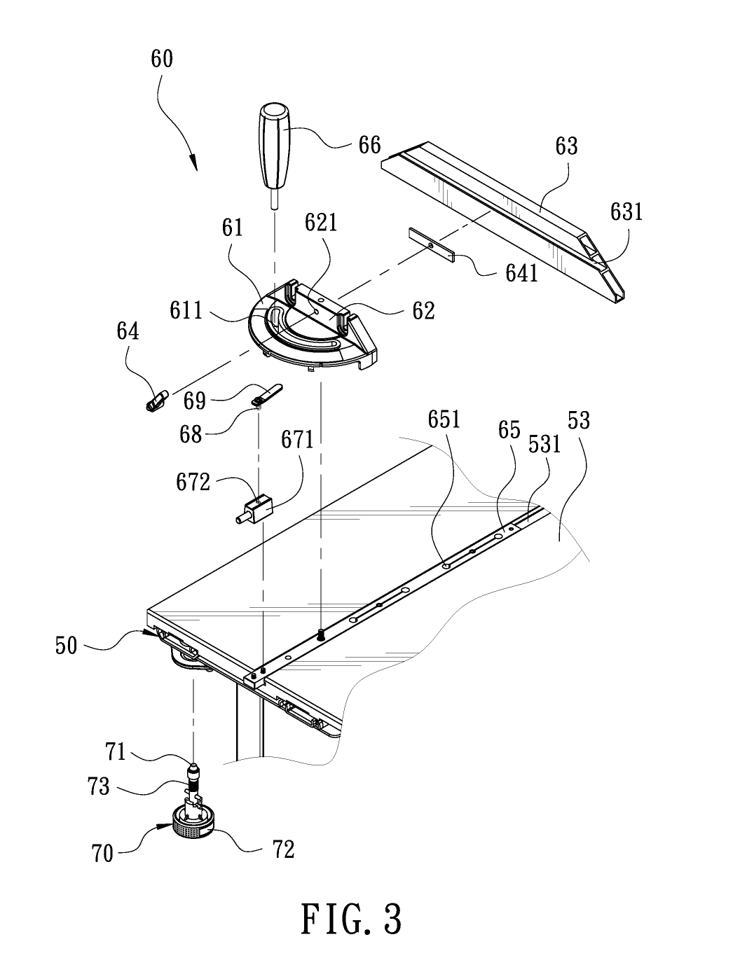

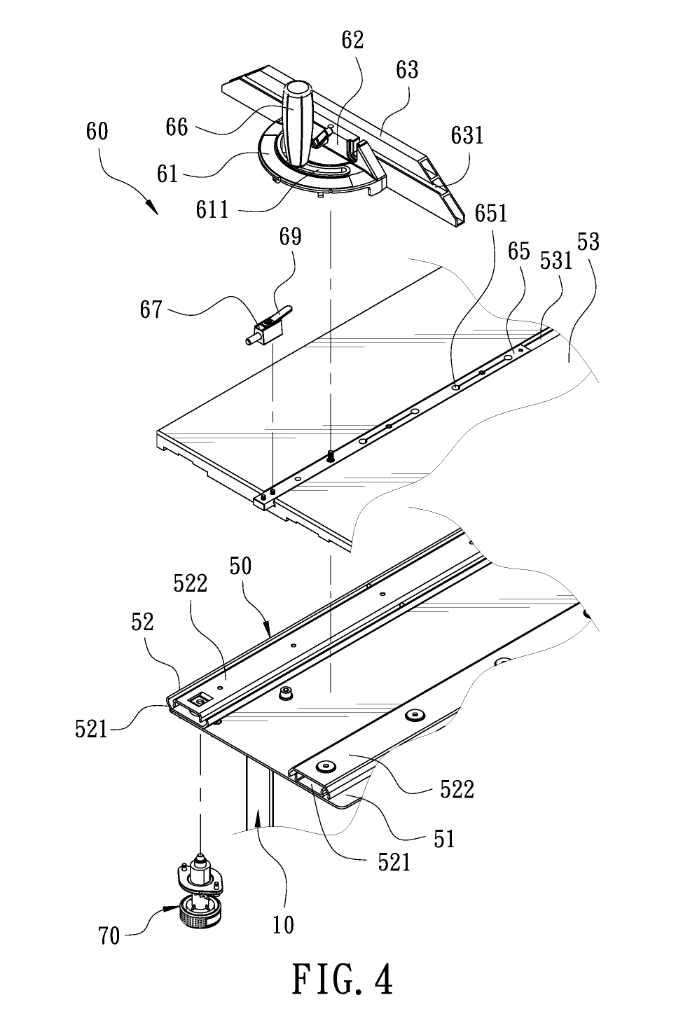

FIG. 2 is a first partial exploded view of the preferred embodiment of the present invention. FIG. 3 is a second partial exploded view of the preferred embodiment of the present invention. FIG. 4 is a third partial exploded view of the preferred embodiment of the present invention. The present invention discloses a slidable workbench 100. The slidable workbench is mounted to a table saw 200. The table saw 200 comprises a machine base 10, a seat unit 20, a power mechanism 30, a circular saw blade 40, a shifting mechanism 50, a push member 60, and a brake member 70.

The machine base 10 has an accommodation space 11 therein. The top of the machine base 10 is provided with a worktable 12. The worktable 12 is formed with an elongate hole 13 in communication with the accommodation space 11. In the present invention, the bottom side of the worktable 12 of the machine base 10 is provided with two spaced adjustment members 14. One side of each adjustment member 14 has an adjustment trough 141. The adjustment trough 14 is formed with a second adjustment hole 142. The adjustment trough 141 and the second adjustment hole 142 each have an arc shape. The machine base 10 has a third adjustment hole 15. The third adjustment hole 15 corresponds to the second adjustment hole 142 and has an arc shape. Furthermore, the worktable 12 has a rectangular hole 16. The rectangular hole 16 is provided with a flat board 17. The flat board 17 has the elongate hole 13.

The seat unit 20 is disposed in the accommodation space 11. The seat unit 20 comprises a first fixing seat 21, a second fixing seat 22, and a third fixing seat 23 which are spaced each other. The first fixing seat 21 is provided with two shafts 24 which are disposed vertically. The shafts 24 have free ends penetrating the second fixing seat 22 and secured to the third fixing seat 23. In the present invention, the adjustment members 14 are disposed at two sides of the first fixing seat 21. The first fixing seat 21 is provided with a pair of adjustment blocks 211 corresponding to the adjustment troughs 141 of the adjustment members 14. The top of the second fixing seat 22 is provided with a connecting block 221. The connecting block 221 has a connecting hole 222 therein. The second fixing seat 22 further has an elevating block 223 facing the side wall of the machine base 10. The elevating block 223 has a threaded hole 224. The third fixing seat 23 has a through hole 231 corresponding to the threaded hole 224.

The power mechanism 30 is disposed in the accommodation space 11. The power mechanism 30 is connected with the second fixing seat 22. In the present invention, the power mechanism 30 comprises a motor 31. The motor 31 is fixed to a first side of the second fixing seat 22. The motor 31 is provided with an output shaft 32 toward the direction of a second side of the second fixing seat 22. A free end of the output shaft 32 is fitted with a drive wheel 33. The power mechanism 30 further comprises a drive shaft 34. The drive shaft 34 has a retaining section 341. The retaining section 341 is inserted through the connecting hole 222 and pivoted to the second fixing seat 22. The drive shaft 34 has a drive section 342 protruding out of the second side of the second fixing seat 22. A belt 35 is provided and fitted on the drive wheel 33 and the drive section 342 of the drive shaft 34.

The circular saw blade 40 is connected with the power mechanism 30 and exposed out of the elongate hole 13. In the present invention, the circular saw blade 40 has a central hole 41. The connecting hole 222 of the second fixing seat 22 and the central hole 41 are concentric. A free end of the drive section 342 of the drive shaft 34 is inserted through the central hole 41 and fixed to the circular saw blade 40.

The shifting mechanism 50 is disposed at one side of the worktable 12 close to the circular saw blade 40. The shifting mechanism 50 comprises a fixed board 51, two slide rails 52, and a sliding platform 53. The fixed board 51 is fixed to the machine base 10. The slide rails 52 each comprise an immovable section 521 and a movable section 522. The immovable sections 521 of the slide rails 52 are parallel to the elongate hole 13 The immovable sections 521 of the slide rails 52 are disposed on the top surface of the fixed board 51 and spaced at an interval. The movable sections 522 of the slide rails 52 are disposed at the bottom surface of the sliding platform 53, enabling the sliding platform 53 to slide on the fixed board 51 through the slide rails 52. The sliding platform 53 has a positioning groove 531 parallel to the elongate hole 13.

The push member 60 is fixedly connected to the sliding platform 53. The push member 60 comprises a base 61. The base 61 has a curved first adjustment hole 611. One side of the base 61 is provided with a coupling block 62. The coupling block 62 has a coupling hole 621. The push member 60 further comprises a push board 63 which is disposed perpendicular to the slide rails 52. The push board 63 is formed with a transverse engaging groove 631 corresponding to the coupling hole 621. The push member 60 further comprises a first limit lever 64 and a limit board 641 corresponding to the engaging groove 631. The first limit lever 64 is inserted through the coupling hole 621 and connected to the engaging groove 631 through the limit board 641. The push member 60 further comprises a positioning board 65 which is disposed in the positing groove 531. The positioning board 65 has a plurality of spaced positioning holes 651 corresponding to the first adjustment hole 611. The push member 60 comprises a second limit lever 66. One end of the second limit lever 66 is inserted through the first adjustment hole 611 and one of the positioning holes 651, such that the base 61 is coupled to the positioning board 65 and fixed to the sliding platform 53. The push member 60 further comprises a stopper 67. The stopper 67 has a stop block 671. The stop block 671 is fixedly connected to the positioning board 65. The stop block 671 has a through hole 672. The through hole 672 is provided with a fixing lever 68. One end of the fixing lever 68 is screwedly connected to the positioning board 65. The top of the stop block 671 is provided with a press plate 69. A first end of the press plate 69 is screwedly connected to the stop block 671. A free end of the press plate 69 is tilted upward.

The brake member 70 comprises a press lever 71. A first end of the press lever 71 is provided with a press button 72. A spring 73 is provided and fitted on the press lever 71. A second end of the press lever 71 is against the movable section 522 of one of the slide rails 52.

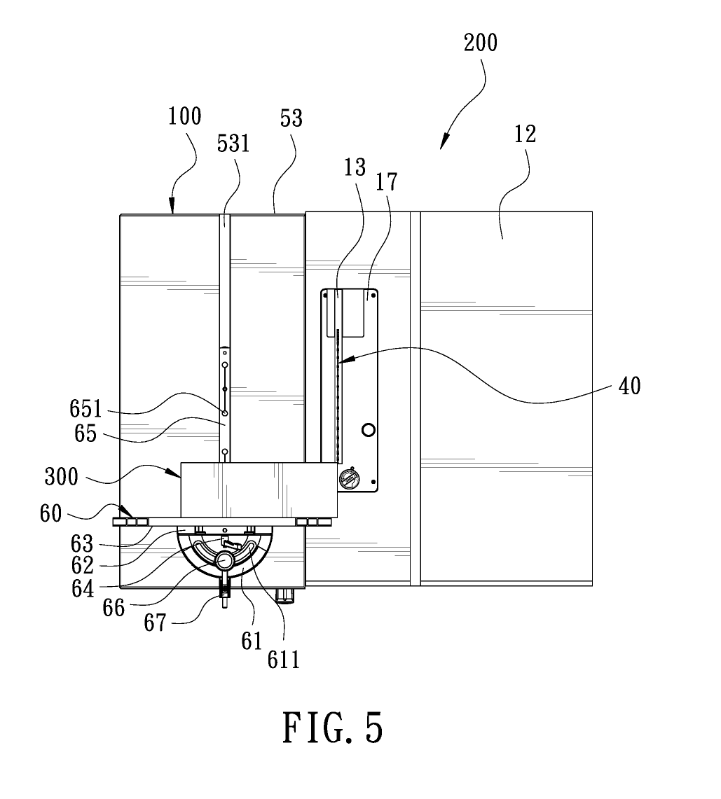

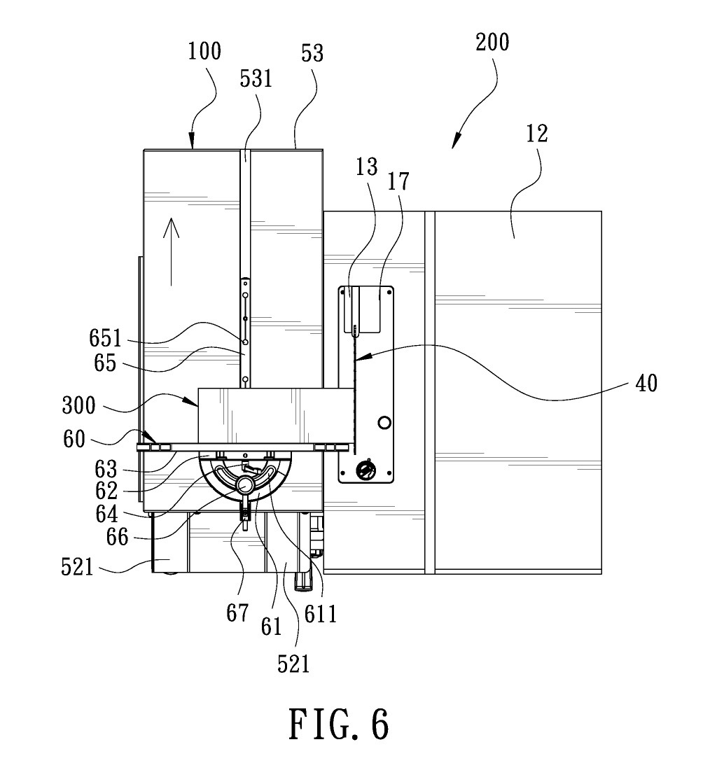

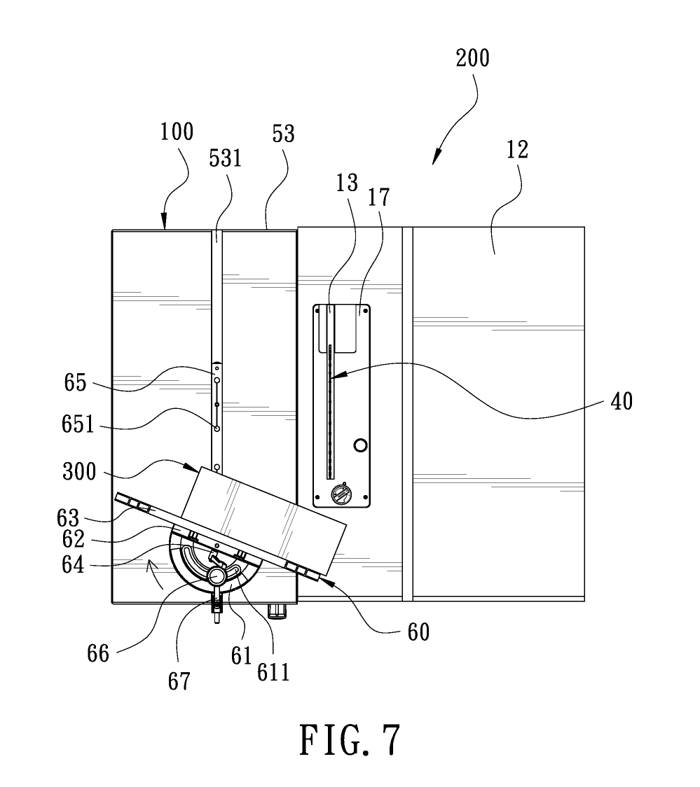

As shown in FIG. 5 and FIG. 6, the motor 31 is first actuated to drive the circular saw blade 40 to turn. A workpiece 300 is quickly positioned on the sliding platform 53 through the push board 63. The push member 60 is pushed to bring the sliding platform 53 to move toward the circular saw blade 40 for cutting. As shown in FIG. 7, when the user wants the workpiece 300 to be cut at an angle, the push member 60 is turned an angle through the first adjustment hole 611 of the push member 60 and the workpiece 300 leans against the push board 63 which is disposed at an angle for cutting. Thereby, the workpiece 300 is pushed by the push member 60 and the sliding platform 53 is slidable relative to the fixed board 51 for the user to operate the table saw in a quick, labor-saving and easy manner.

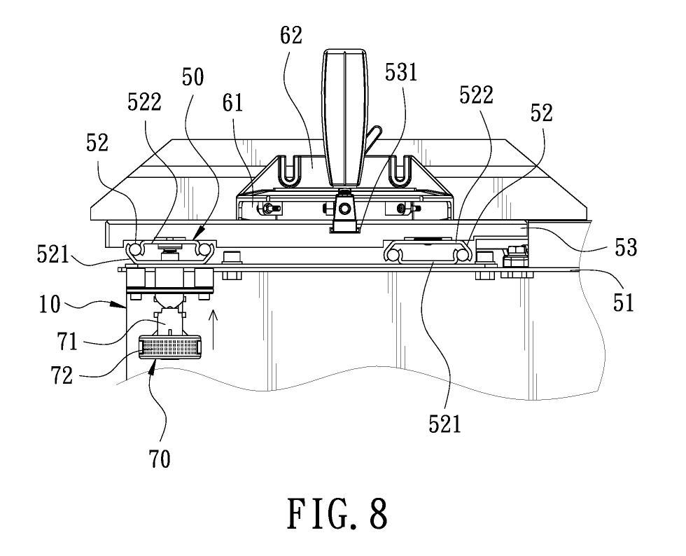

FIG. 8 is a schematic view, showing that the present invention is braked. When the user wants to stop cutting, the press button 72 of the brake member 70 is pressed for the press lever 71 to hold against the movable section 522 of the slide rail 52 to stop the sliding platform 53 so as to brake the table saw.

It is noted that the power mechanism 30 is connected with the second fixing seat 22 and the circular saw blade 40 respectively to shorten the distance between the motor 31 and the circular saw blade 40, enabling the sliding platform 53 and the circular saw blade 40 to be kept at a short distance. The short distance is in the range of 50 mm to 70 mm. In a preferred embodiment, the short distance is 59 mm to enhance the convenience of the table saw 200.

Thereby, the workpiece 300 is pushed by the push member 60 and the sliding platform 53 is slidable relative to the fixed board 51 for the user to operate the table saw in a quick, labor-saving and easy manner. The slidable workbench 100 can be used for all kinds of saw machines, not limited to the table saw 200, which can enhance the convenience and safety of the saw machines greatly and improve the quality of cutting.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A slidable workbench, comprising:
a shifting mechanism, the shifting mechanism comprising a fixed board, two slide rails, and a sliding platform, the slide rails each comprising an immovable section and a movable section, the immovable sections of the slide rails being disposed on a top surface of the fixed board and spaced at an interval, the movable sections of the slide rails being disposed at a bottom surface of the sliding platform, enabling the sliding platform to slide on the fixed board through the slide rails; and
a push member, the push member being fixedly connected to the sliding platform;
thereby, the push member being adapted to push a workpiece and the sliding platform being slidable relative the fixed board for cutting.

2. The slidable workbench as claimed in claim 1, wherein the push member comprises a base, the base has a curved first adjustment hole, one side of the base is provided with a coupling block, the coupling block has a coupling hole, the push member further comprises a push board which is disposed perpendicular to the slide rails, the push board is formed with a transverse engaging groove corresponding to the coupling hole, the push member further comprises a first limit lever and a limit board corresponding to the engaging groove, the first limit lever is inserted through the coupling hole and connected to the engaging groove through the limit board, the push member further comprises a positioning board which is slidably disposed on the sliding platform, the positioning board has a plurality of spaced positioning holes corresponding to the first adjustment hole, the push member comprises a second limit lever, and one end of the second limit lever is inserted through the first adjustment hole and one of the positioning holes, such that the base is coupled to the positioning board and fixed to the sliding platform.

3. The slidable workbench as claimed in claim 2, wherein the push member comprises a stopper, the stopper has a stop block, the stop block is fixedly connected to the positioning board, the stop block has a through hole facing the positioning board, the through hole is provided with a fixing lever, one end of the fixing lever is screwedly connected to the positioning board, a top of the stop block is provided with a press plate, a first end of the press plate is screwedly connected to the stop block, and a free end of the press plate is tilted upward.

4. The slidable workbench as claimed in claim 1, further comprising a brake member, the brake member being fixedly connected to a bottom side of the fixed board, the brake member comprising a press lever, a first end of the press lever being provided with a press button, a spring being provided and fitted on the press lever, a second end of the press lever being against the movable section of one of the slide rails.

5. A slidable workbench, mounted to a table saw, the table saw comprising a machine base, the machine base having an accommodation space therein, a top of the machine base being provided with a worktable, the worktable being formed with an elongate hole in communication with the accommodation space, the enlogate hole being provided with a circular saw blade, the slidable workbench being disposed at one side of the worktable, the slidable workbench comprising:
a shifting mechanism, the shifting mechanism comprising a fixed board, two slide rails, and a sliding platform, the slide rails each comprising an immovable section and a movable section, the immovable sections of the slide rails being disposed on a top surface of the fixed board and spaced at an interval, the movable sections of the slide rails being disposed at a bottom surface of the sliding platform, enabling the sliding platform to slide on the fixed board through the slide rails; and
a push member, the push member being fixedly connected to the sliding platform;
thereby, the push member being adapted to push a workpiece and the sliding platform being slidable relative the fixed board for cutting.

6. The slidable workbench as claimed in claim 5, wherein the push member comprises a base, the base has a curved first adjustment hole, one side of the base is provided with a coupling block, the coupling block has a coupling hole, the push member further comprises a push board which is disposed perpendicular to the slide rails, the push board is formed with a transverse engaging groove corresponding to the coupling hole, the push member further comprises a first limit lever and a limit board corresponding to the engaging groove, the first limit lever is inserted through the coupling hole and connected to the engaging groove through the limit board, the push member further comprises a positioning board which is slidably disposed on the sliding platform, the positioning board has a plurality of spaced positioning holes corresponding to the first adjustment hole, the push member comprises a second limit lever, and one end of the second limit lever is inserted through the first adjustment hole and one of the positioning holes, such that the base is coupled to the positioning board and fixed to the sliding platform.

7. The slidable workbench as claimed in claim 6, wherein the push member comprises a stopper, the stopper has a stop block, the stop block is fixedly connected to the positioning board, the stop block has a through hole facing the positioning board, the through hole is provided with a fixing lever, one end of the fixing lever is screwedly connected to the positioning board, a top of the stop block is provided with a press plate, a first end of the press plate is screwedly connected to the stop block, and a free end of the press plate is tilted upward.

8. The slidable workbench as claimed in claim 5, further comprising a brake member, the brake member being fixedly connected to a bottom side of the fixed board, the brake member comprising a press lever, a first end of the press lever being provided with a press button, a spring being provided and fitted on the press lever, a second end of the press lever being against the movable section of one of the slide rails.

9. The slidable workbench as claimed in claim 5, wherein a distance defined between the sliding platform and the circular saw blade is in the range of 50 mm to 70 mm.

10. The slidable workbench as claimed in claim 5, wherein a distance defined between the sliding platform and the circular saw blade is 59 mm.
